(19) United States
(12) Patent Application Publication
(10) Pub. No.: US 2011/0155552 A1
(43) Pub. Date: Jun. 30, 2011

(54) SUPPORTING STRUCTURE, KEYSWITCH, AND KEYBOARD

(76) Inventor: Yi-Chen WANG, Yongkang City (TW)

(21) Appl. No.: 12/757,875

(22) Filed: Apr. 9, 2010

(30) Foreign Application Priority Data
Apr. 13, 2009 (TW) 098206036

(51) Int. Cl. H01H 13/70; H01H 13/14

(52) U.S. Cl. 200/5 A; 200/344

(57) ABSTRACT

A supporting structure includes two supporting members. Each of the supporting members has a connecting portion, a first side arm, and a second side arm. The first side arm and the second side arm are connected opposite to the connecting portion respectively. The first side arm protrudes to form a shaft and the second side arm forms a hole corresponding to the shaft. The shaft of each of the two supporting members can be rotatable contained in the hole of another supporting member respectively. The shape of the supporting member is similar to a U shape.

### BACKGROUND OF THE INVENTION

1. Field of the Invention

The invention relates to supporting structure for connecting and supporting a keycap, and particularly, the invention relates to a novel scissors-type supporting structure and the keyswitch and the keyboard using the same.

2. Description of the Prior Art

For communicating with the computer and executing the functions of the computer, people use various input device, such as keyboard, a mouse, and a touch pen, wherein the keyboard is one of the indispensable devices for operating the computer. Generally, the keyboard comprises a base and a plurality of keyswitch configured on the base. Each keyswitch includes a keycap, a supporting structure, an elastic object, and a switch. The switch is configured on the base to control the delivery of signals. The supporting structure is connected to the base and the keycap for supporting the keycap on the base. The elastic object is configured in the vacant space of the supporting structure.

When the user presses the keycap, the keycap presses the elastic object and then the supporting structure drives the elastic object to move toward the switch, so that the switch can be triggered and then generate the signal. When the external force disappears from the keycap, the elastic object recovers the original shape to make the keycap back to the original position and to stop generating the signal.

One of many types of the supporting structure used is scissors-type supporting structure. The scissors-type supporting structure is mainly constructed by two supporting members pivotal connected to each other. Please refer to FIG. 1. FIG. 1 is a schematic diagram illustrating the supporting structure 1 in the prior art. As shown in FIG. 1, the supporting structure 1 has a first supporting member 11 and a second supporting member 13. The first supporting member 11 has a first connecting portion 110, a first side arm 111, a third side arm 113, a first pivotal connecting portion 115, and two third pivotal connecting portions 117 and 119. The first side arm 111 and the third side arm 113 are respectively connected to the first connecting portion 110. The first side arm 111 and the third side arm 113 respectively have shafts 1110 and 1130. The two ends of the first pivotal connecting portion 115 are respectively connected to the first side arm 111 and the third side arm 113, and the two ends can be configured at the base (not shown in the figure) of the keyswitch to be connected to the base. The third pivotal connecting portions 117 and 119 are respectively located at two sides of the first connecting portion 110 and used for connecting the keycap (not shown in the figure) of the keyswitch.

The second supporting member 13 has a second connecting portion 130, a second side arm 131, a fourth side arm 133, two second pivotal connecting portions 135 and 137, and a fourth pivotal connecting portion 139. The second side arm 131 and the fourth side arm 133 are respectively connected to the second connecting portion 130. The second side arm 131 and the fourth side arm 133 respectively have holes 1310 and 1330 corresponding to the shafts 1110 and 1130. The second pivotal connecting portions 135 and 137 are respectively located at the sides, far away from the second connecting portion 130, of the second side arm 131 and the fourth side 133 for connecting the base of the keyswitch. The fourth pivotal connecting portion 139 is configured at two sides of the second connecting portion 130 for connecting the keycap of the keyswitch.

When assembling the supporting structure 1, the shaft 1110 of the first side arm 111 is aligned to and then pivotal connected to the hole 1310 of the second side arm 131, and the shaft 1130 of the third side arm 113 is aligned to and then pivotal connected to the hole 1330 of the fourth side arm 133. Accordingly, the first supporting member 11 and the second supporting member 13 can rotate relatively to each other through the shafts 1110 and 1130, so that the keycap supported by the supporting structure 1 can move perpendicularly to the base.

As described above, the supporting structure 1 needs manpower to be assembled or disassembled, and much time and manpower consume in the assembling or disassembling processes. Besides, the supporting structure 1 might be damaged by improper force in the assembling processes to increase the cost.

### SUMMARY OF THE INVENTION

Therefore, a scope of the invention is to provide novel supporting structure to solve the problem in the prior art.

According to an embodiment of the invention, the supporting structure includes two supporting members. Each supporting member has a connecting portion, a first side arm, and a second side arm. The first side arm and the second side arm are respectively connected the connecting portion. The first side arm protrudes to form a shaft and the second side arm forms a hole corresponding to the shaft. Each shaft of one supporting member can be respectively contained in the hole of the other supporting member.

Another scope of the invention is to provide a keyswitch to solve the problem in the prior art.

According to an embodiment of the invention, the keyswitch includes a base, a keycap, and a supporting structure. The supporting structure is configured between the keycap and the base, and it includes two supporting members capable of rotating relative to each other through the shafts and holes. The details of the conformations and functions have been described as above. Besides, the supporting structure is connected to the keycap and the base, and accordingly, the keycap can move relatively to the base.

Another scope of the invention is to provide a keyboard to solve the problem in the prior art.

According to an embodiment of the invention, the keyboard includes a base, a plurality of keycaps, and a plurality of supporting structures. The keycaps are configured on the base. The supporting structures are respectively configured between the keycap and the base, and it includes two supporting members capable of rotating relative to each other through the shafts and holes. The detail of the conformations and functions has been described as above. Besides, the supporting structure is connected to the keycap and the base, and accordingly, the keycap can move relatively to the base. The details of the supporting structure in the embodiment have been described as above, and it would not be described here.

In the prior art, the supporting structure is composed of two supporting member with different shapes. Compared to the prior art, the supporting art of the invention is composed of two supporting member with the same shape, and accordingly, the fabricating processes can be simplified. Besides, the supporting structure of the invention can be assembled by jig. The jig can make the two supporting members to move in parallel, so that a shaft of one supporting member can be obtained in a hole of the other supporting member. Therefore, the damage of the supporting structure or keyswitch caused by improper force in the man-made assembling processes can be avoided. Furthermore, the supporting structure of the invention can rotate more smoothly than that in the prior art.

These and other features, aspects, and advantages of the present invention will become better understood with regard to the following description, appended claims, and accompanying drawings.

### BRIEF DESCRIPTION OF THE APPENDED DRAWINGS

FIG. 1 is a schematic diagram illustrating the supporting structure in the prior art.

FIG. 2A is a schematic diagram illustrating a supporting structure according to an embodiment of the invention.

FIG. 2B is another schematic diagram illustrating the supporting structure in FIG. 2A.

FIG. 2C is a schematic diagram illustrating a supporting structure according to another embodiment of the invention.

FIG. 2D is another schematic diagram illustrating the supporting structure in FIG. 2C.

FIG. 3A is a schematic diagram illustrating a supporting structure according to another embodiment of the invention.

FIG. 3B is another schematic diagram illustrating the supporting structure in FIG. 3A.

FIG. 4 is a schematic diagram illustrating supporting structures according to an embodiment of the invention.

FIG. 5 is a schematic diagram illustrating a keyswitch according to an embodiment of the invention.

FIG. 6 is a schematic diagram illustrating a keyswitch according to an embodiment of the invention.

FIG. 7 is a schematic diagram illustrating the keyboard according to an embodiment of the invention.

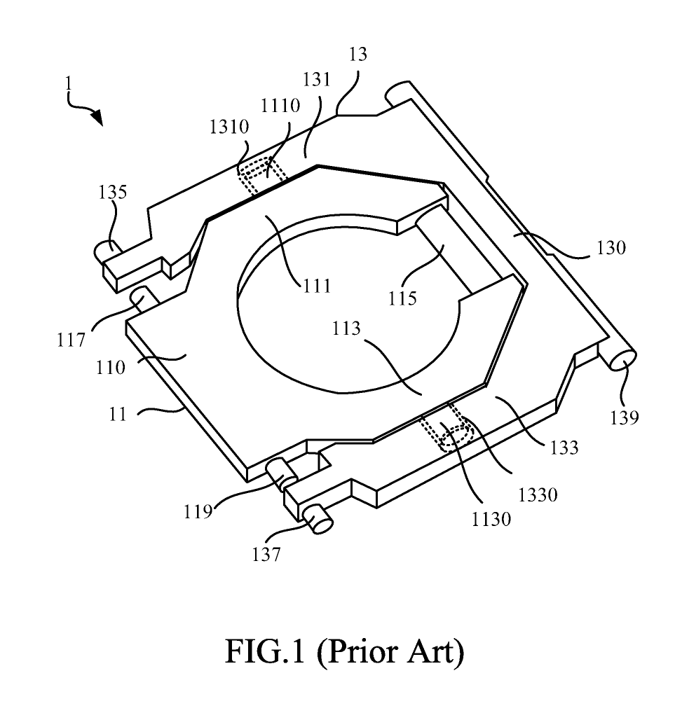

### DETAILED DESCRIPTION OF THE INVENTION

The invention provides a supporting structure, a keyswitch, and a keyboard using the supporting structure. The supporting structure, which is scissors-type, of the invention can support and connect the keycap of the keyswitch.

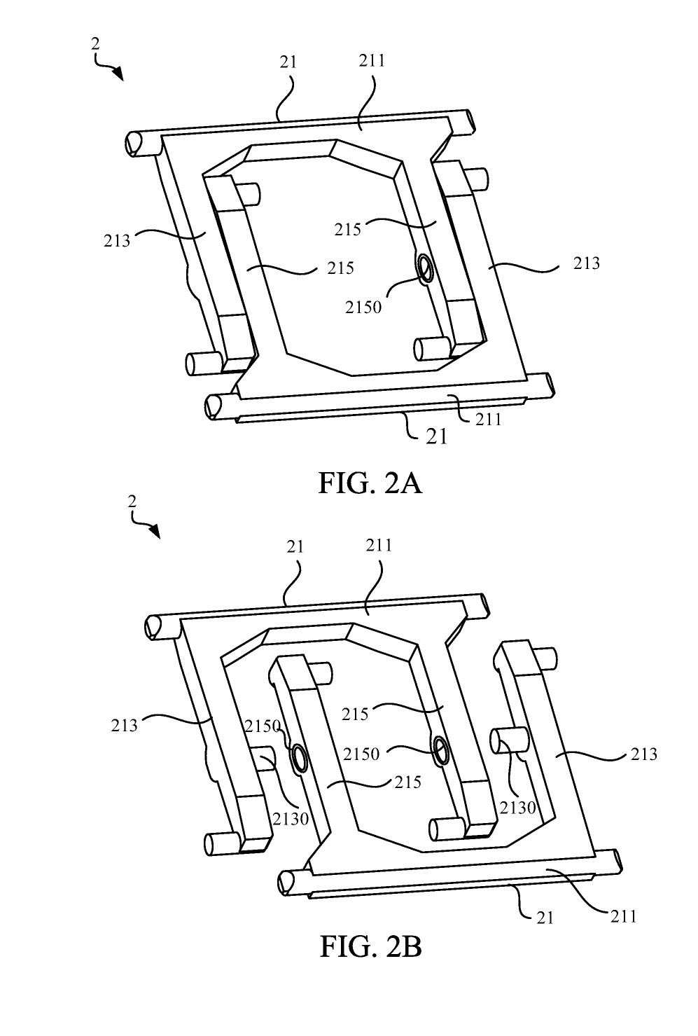

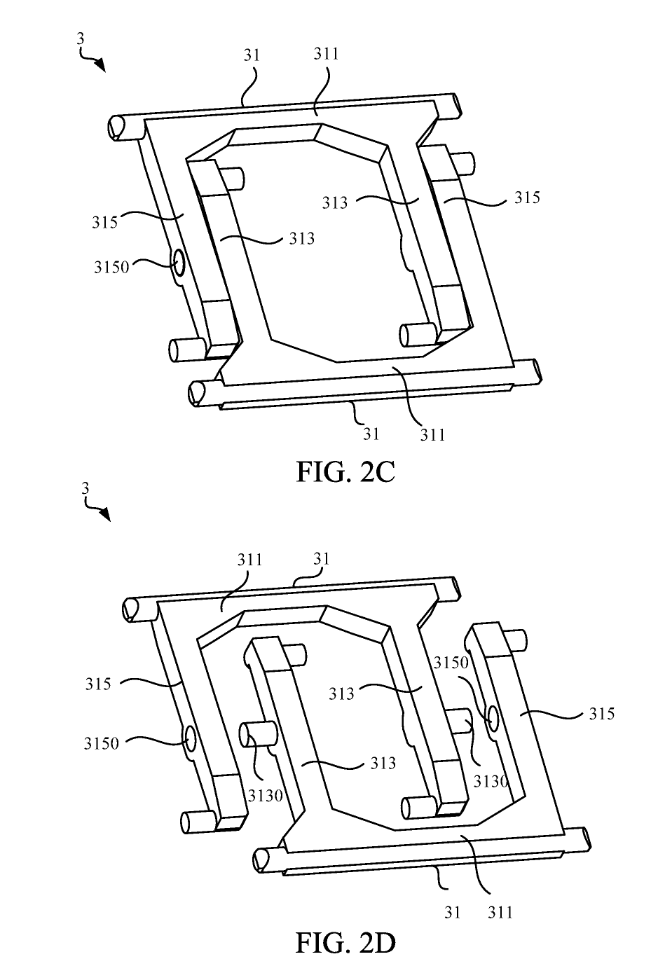

Please refer to FIG. 2A and FIG. 2B. FIG. 2A is a schematic diagram illustrating a supporting structure 2 according to an embodiment of the invention. FIG. 2B is another schematic diagram illustrating the supporting structure 2 in FIG. 2A. As shown in FIG. 2A and FIG. 2B, the supporting structure 2 in the embodiment includes two supporting member 21 with similar shapes. Each supporting member 21 has a connecting portion 211, a first side arm 213 and a second side arm 215. The first side arm 213 and the second side arm 215 are respectively connected to the connecting portion 211 to make the shape of the supporting member 21 to be similar to a U shape. The first side arm 213 protrudes toward the second side arm 215 to form a shaft 2130, and the position of the shaft 2130 would be at the middle of the first side arm 213. The second side arm 215 forms a hole 2150 corresponding to the shaft 2130. The position of the hole 2150, which is at the middle of the second side arm 215, is corresponding to the position of the shaft 2130. The shaft 2130 and the hole 2150 are similar to a cylinder, and the external diameter of the shaft 2130 is slightly smaller than the internal diameter of the hole 2150. When assembling the supporting structure 2, the first side arm 213 and the second side arm 215 of one supporting member 21 are in staggered arrangement with those of the other supporting member 21 (as shown in FIG. 2A). The shaft 2130 is aligned to the hole 2150, and then each shaft 2130 of one supporting member 21 is rotatably contained in the corresponding hole 2150 of the other supporting member 21 to be connected to each other. Besides, when the shaft 2130 of one supporting member 21 is contained in the hole 2150 of the other supporting member 21, the two supporting member 21 can rotate relatively to the shaft 2130. In practice, the two shafts 2130 of the supporting structure 2 are on the same axis, so that the supporting members 21 rotate relatively to the connecting line of the two shafts 2130.

In practice, the protruding direction of the shaft 2130 is not limited to the direction toward the second side arm 215. Please refer to FIG. 2C and FIG. 2D. FIG. 2C is a schematic diagram illustrating a supporting structure 3 according to another embodiment of the invention. FIG. 2D is another schematic diagram illustrating the supporting structure 3 in FIG. 2C. As shown in FIG. 2C and FIG. 2D, the supporting structure 3 in the embodiment includes two supporting member 31 with similar shapes. Each supporting member 31 has a connecting portion 311, a first side arm 313 and a second side arm 315. The first side arm 313 protrudes away from the second side arm 315 to form a shaft 3130. The second side arm 315 forms a hole 3150 corresponding to the shaft 3130. Accordingly, each shaft 3130 of one supporting member 31 can be rotatably contained in the corresponding hole 3150 of the other supporting member 31. The details of the supporting member 31 and the method for assembling the supporting structure 3 are described as above, and it would not be described here again. The difference between the embodiment and the last embodiment as shown in FIG. 2A and FIG. 2B is that the shaft 3130 protrudes away from the second side arm 315 but not toward the second side arm as shown in FIG. 2A and FIG. 2B.

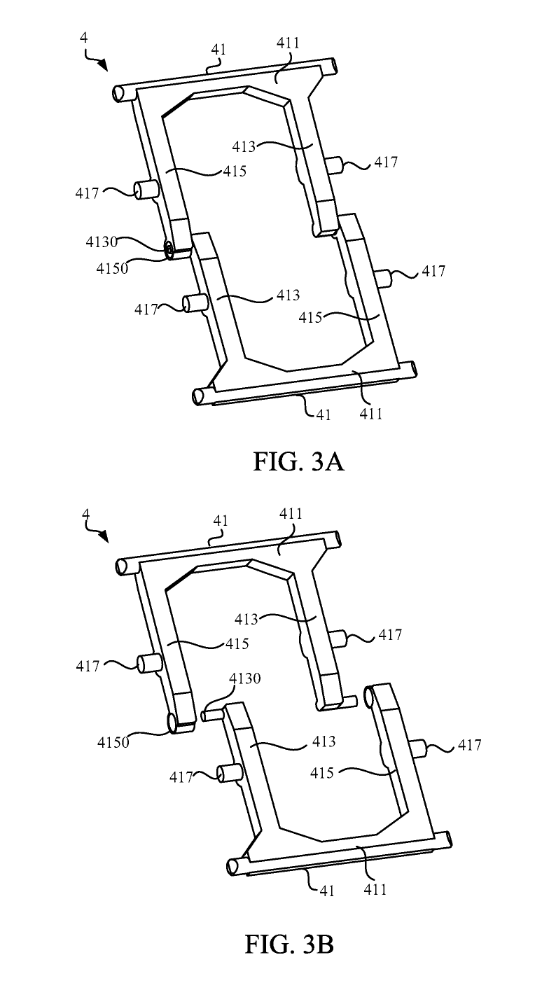

In practice, the position of the shaft is not limited to the middle of the first side arm, and it can be one terminal away from the connecting portion. Please FIG. 3A and FIG. 3B. FIG. 3A is a schematic diagram illustrating a supporting structure 4 according to another embodiment of the invention. FIG. 3B is another schematic diagram illustrating the supporting structure 4 in FIG. 3A. As shown in FIG. 3A and FIG. 3B, the supporting structure 4 in the embodiment includes two supporting member 41 with similar shapes. Each supporting member 41 has a connecting portion 411, a first side arm 413, a second side arm 415, and a plurality of connecting shafts 417. The first side arm 413 protrudes away from the second side arm 415 to form a shaft 4130, and the position of the shaft 4130 is located at one terminal away from the connecting portion 411. The second side arm 415 forms a hole 4150 corresponding to the shaft 4130, and the position of the hole 4150 is located at one terminal away from the connecting portion 411 and is corresponding to the position of the shaft 4130. Besides, the difference between the embodiment and the embodiments above is that the diameter of the hole 4150 is larger than that of the shaft 4130, and accordingly, each shaft 4130 of one supporting member 41 can be rotatably and slidely contained in the corresponding hole 4150 of the other supporting member 41. The connecting shaft 417 is used for being connected to a base (not shown in the figures), and the two terminals of the connecting portions 411 of the two supporting member 41 are connected to a keycap (not shown in the figures). In the embodiment, the shaft 4130 protrudes away from the second side arm 415. However, the shaft 4130 can protrude toward the second side arm 415. The hole 4150 is not limited to a hollow cylinder, and it can be a hollow elliptic cylinder or other configuration sufficient to enable the shaft 4130 to slide therein.

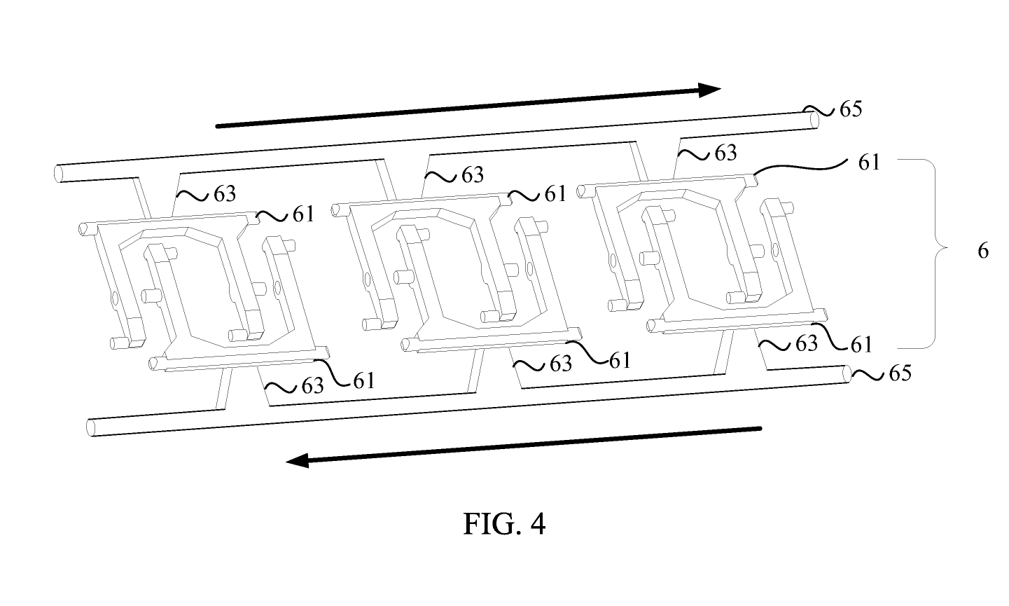

Because the supporting structure of the invention is composed of two supporting member with the same shape, the supporting structure of the invention can be fabricated and assembled through the following method to save time and manpower. Firstly to prepare the mold, the mold includes two parallel runners and a plurality of cavities with the same shape as the supporting member. The cavities face to each other in staggered arrangement and are connected to the runners respectively. On the suitable pressure and temperature condition, the material is injected into the cavities through the runners. When the material is injected in the cavities, a plurality of crops, which are connected to the runners and the supporting members, form at the connection parts between the cavities and the runners. After the supporting structures and crops forming, the mold is taken off to finish the fabrication. Please refer to FIG. 4. FIG. 4 is a schematic diagram illustrating supporting structures 6 according to another embodiment of the invention. As shown in FIG. 4, the supporting structures 6 after taking off the mold (the structures are shown in, but not limited to, FIG. 2C and FIG. 2D) are connected to each other by the crops 63 and the runners 65. The supporting members 61 need to be separated from the crop when assembling the supporting structure 6. Because the supporting members 61 are arranged in two staggered rows, many supporting members 61 can be separated from the crops 63 by cutting instrument at once. A plurality of exhaust tubes (not shown in the figures) are configured under the supporting member 61 to carry the supporting member 61 separated. Besides, for decreasing the artificial assemble, a jig can be used for fixing the supporting member 61 arranged in two rows before separating the supporting member 61 from the crops 63, and then making the supporting members 61 to move in parallel after separating the supporting member 61 from crops 63. The moving direction is shown as the arrow in FIG. 4. Accordingly, the shaft of one supporting member 61 can be rotatably contained in the hole of another supporting member 61, and the artificial assemble can be avoided.

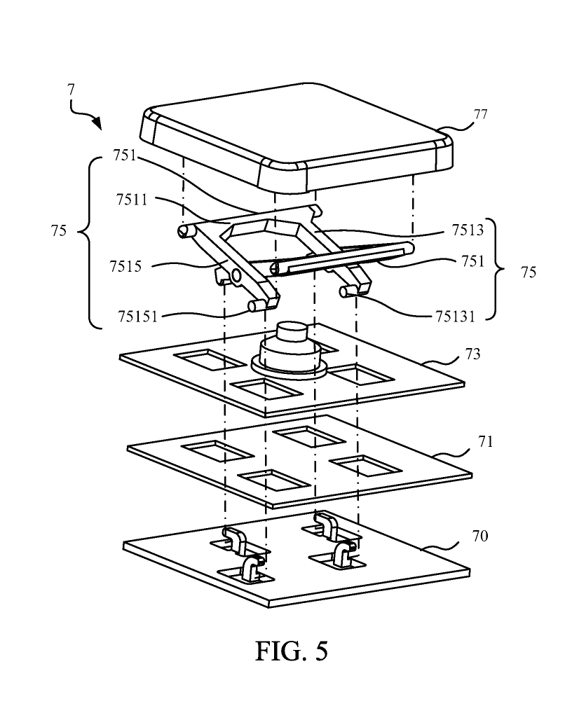

The invention further provides a keyswitch including the supporting structure above-mentioned. Please refer to FIG. 5. FIG. 5 is a schematic diagram illustrating a keyswitch 7 according to an embodiment of the invention. As shown in FIG. 5, the keyswitch 7 includes a base 70, a flexible printing circuit board 71, a rubber pad 73, a supporting structure 75, and a keycap 77. The flexible printing circuit board 71 is configured on the base 70, and the keycap 77 is configured on the flexible printing circuit board 71 and the base 70. The supporting structure 75 is configured between the keycap 77 and the base 70, and connected to the keycap 77 and the base 70. The rubber pad 73 is configured in the space of the supporting structure 75 to be the medium communicating the user and the circuit of the flexible printing circuit board 71.

The construction of the supporting structure 75 is the same as the supporting structure 31 shown in FIG. 2C. The supporting structure 75 includes two supporting member 751 capable of rotating relatively to each other. The supporting member 751 has a connecting portion 7511, a first side arm 7513, and a second side arm 7515. The connecting portion 7511 of one supporting member 751 is pivotally connected to the keycap 77, and the connecting portion 7511 of the other supporting member 751 is slidely connected to the keycap 77. The terminals, away from the connecting portion 7511, of the first side arm 7513 and the second side arm 7515 of the supporting member 751 include a first connecting portion 75131 and a second connecting portion 75151 for connecting to the base 70. When the supporting member 751 is connected to the base 70 and the keycap 77, the keycap 77 can move toward the base 70 through the driving of the supporting structure 75. In the embodiment, the supporting member 751 is the same as, but not limited to, the supporting member 31 shown in FIG. 2C and FIG. 2D, and the details of the constructions and the functions would not be described here. For example, the supporting member 751 can be the same as the supporting member 21 and 41 shown in FIG. 2A and FIG. 3A.

The flexible printing circuit board 71 is configured on the base 70, and it is composed of three thin films. The three thin films are positive circuit thin film, a negative circuit thin film, and a isolating thin film configured between the positive circuit thin film and the negative circuit thin film. When the user presses the keycap 77, the keycap 77 presses the rubber pad 73 and the supporting structure 75. The keycap 77 and the rubber pad 73 move toward the base 70 through the driving of the supporting structure 75, and further compress the flexible printing circuit board 71 to make the positive circuit thin film to contact the negative circuit thin film from the isolating state. A contacting signal is generated when the positive circuit thin film contacts the negative circuit thin film. Once the external force disappearing from the keycap 77, the supporting structure 75 recoveries to the original state caused by the restoring force provided by the rubber pad 73 to make the keycap 77 back to the original position, and then the flexible printing circuit board 71 stops generating the contacting signal.

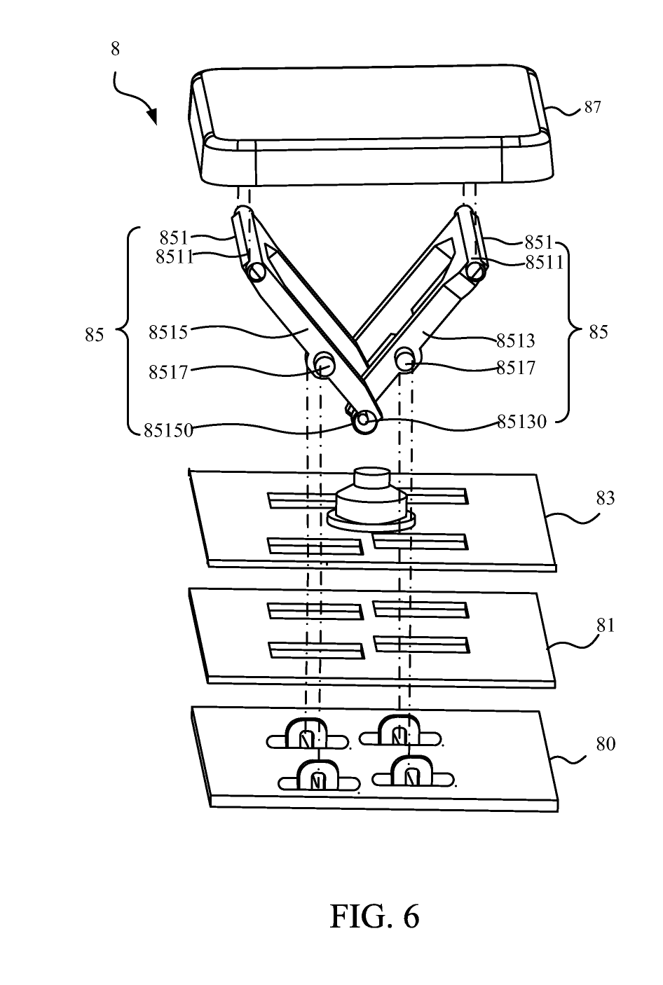

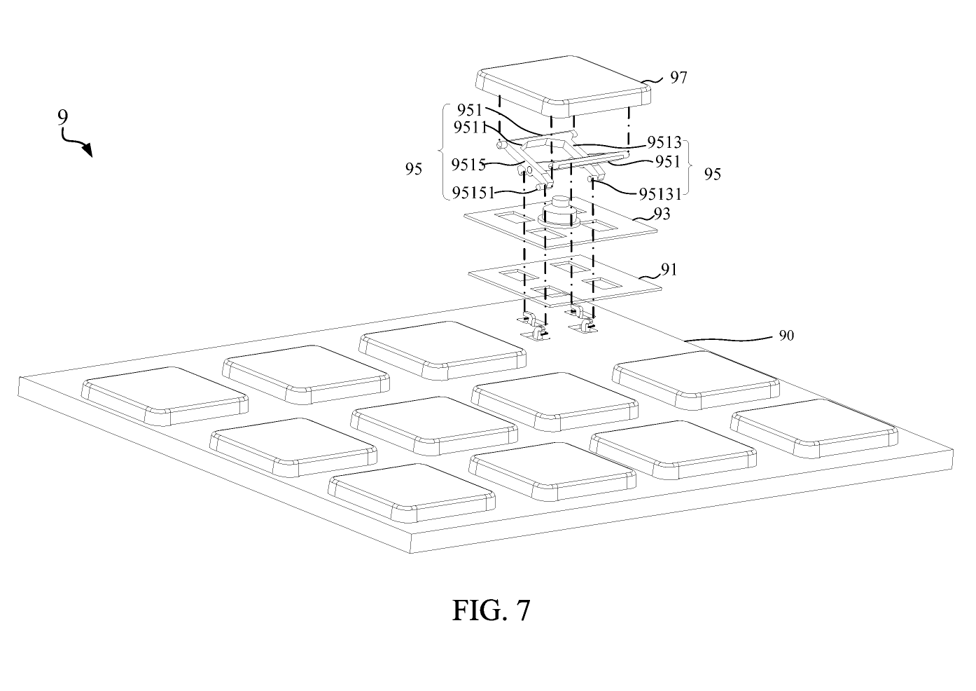

As described above, the supporting structure 75 is not necessary to be the same as that shown in FIG. 2C, and it can be the same as supporting members 21 or 41 shown in FIGS. 2A and 41. Please refer to FIG. 6. FIG. 6 is a schematic diagram illustrating a keyswitch 8 according to an embodiment of the invention. As shown in FIG. 6, the keyswitch 8 includes a base 80, a flexible printing circuit board 81, a rubber pad 83, a supporting structure 85, and a keycap 87. The flexible printing circuit board 81 is configured on the base 80, and the keycap 87 is configured on the flexible printing circuit board 81 and the base 80. The supporting structure 85 is configured between the keycap 87 and the base 80, and connected to the keycap 87 and the base 80. The rubber pad 83 is configured in the space of the supporting structure 85 to be the medium communicating the user with the circuit of the flexible printing circuit board 81. The difference between the embodiment and the last embodiment shown in FIG. 5 is that the construction of the supporting structure 85 is the same as the supporting structure 4 shown in FIG. 3A. The supporting structure 85 includes two supporting member 851 capable of rotating relatively to each other. The supporting member 851 includes a connecting portion 8511, a first side arm 8513, a second side arm 8515, and a plurality of connecting shafts 8517. The first side arm 8513 has a shaft 85130 and the second side arm 8515 has a hole 85150. The connecting portion 8511 of the supporting member 851 is pivotally connected to the keycap 87, and the connecting shafts 8517 are connected to the base 80 respectively. The keycap 87 can move toward the base 70 through the driving of the supporting structure 85. In the embodiment, the supporting member 851 is the same as that shown in FIG. 3A, and the details of the constructions and the functions would not be described here. Besides, the invention further provides a keyboard 9 includes the above-mentioned supporting structure. Please refer to FIG. 7. FIG. 7 is a schematic diagram illustrating the keyboard 9 according to an embodiment of the invention, wherein one of the keyswitches is shown in separation state. As shown in FIG. 7, the keyboard 9 includes a base 90, a flexible printing circuit board 91, a plurality of rubber pads 93, a plurality of supporting structures 95, and a plurality of keycaps 97. The flexible printing circuit board 91 is configured on the base 90, and the keycap 97 is configured on the flexible printing circuit board 91 and the base 90. The supporting structure 95 is configured between the keycap 97 and the base 90. The rubber pad 93 is configured in the space of the supporting structure 95 to be the medium communicating the user and the circuit of the flexible printing circuit board 91.

In the embodiment, the supporting structure 95 includes two supporting member 951 capable of rotating relatively to each other. The supporting member 951 includes a connecting portion 9511, a first side arm 9513, and a second side arm 9515. The connecting portion 9511 of one supporting member 951 is pivotally connected to the keycap 97, and the connecting portion 9511 of the other supporting member 951 is slidely connected to the keycap 97. The terminals, away from the connecting portion 9511, of the first side arm 9513 and the second side arm 9515 of the supporting member 951 further include a first connecting portion 95131 and a second connecting portion 95151 for connecting to the base 90. The details of the constructions and the functions are shown in FIG. 5, and it would not be described here. As described above, when the user presses the keycap 97, the keycap 97 presses the rubber pad 93 and the supporting structure 95, and further compresses the flexible printing circuit board 91, so that the contacting signal is generated. It should be noted that the different contacting signals are respectively generated correspondingly to different keyswitches with different circuits. Once the external force disappearing from the keycap 97, the flexible printing circuit board 91 stops generating the contacting signal.

As described above, the invention is to provide a novel supporting structure for connecting and supporting the keycap. The plurality of supporting structures of the invention can be used for connecting and supporting the plurality of keycaps on a base to form a keyboard. The supporting structure of the invention is composed of two supporting members with the same shape, and accordingly, the time and the fabricating processes can be saved and simplified. Besides, the assemble of supporting structure of the invention can be reached by the jig moving the two supporting members in parallel, and the damage of the supporting structure or keyswitch caused by improper force in the man-made assembling processes can be avoided.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A supporting structure, comprising:
two supporting members, each of the supporting members having a connecting portion, a first side arm, and a second side arm, the first side arm and the second side arm being connected opposite to the connecting portion respectively, the first side arm protruding to form an shaft, the second side arm forming a hole corresponding to the shaft;
wherein the shaft of each of the two supporting members is capable of being rotatable contained in the hole of another supporting member respectively.

2. The supporting structure of claim 1, wherein the shape of the supporting member is similar to a U shape.

3. The supporting structure of claim 1, wherein the two supporting members are connected to each other in staggered arrangement of the first side arms and the second side arms.

4. The supporting structure of claim 1, wherein shaft is located at the middle point or the terminal far away the connecting portion of the first side arm.

5. The supporting structure of claim 1, wherein the hole is located at the middle point or the terminal away from the connecting portion of the second arm.

6. The supporting structure of claim 1, wherein the two supporting member have the same shapes and the shaft protrudes toward or away from the second side arm.

7. A keyswitch, comprising:
a base;
a keycap, configured on the base; and
a supporting structure, configured between and connected to the keycap and the base to enable the keycap to be movable relatively to the base, the supporting structure comprising:
two supporting members, each of the two supporting members having a connecting portion, a first side arm, and a second side arm, the first side arm and the second side arm being connected opposite to the connecting portion respectively, the first side arm protruding to form an shaft, the second side arm forming a hole corresponding to the shaft, wherein the shaft of each of the two supporting member is capable of being rotatable contained in the hole of another supporting member respectively.

8. The keyswitch of claim 7, wherein the shape of the supporting member is approximately a U shape.

9. The keyswitch of claim 7, wherein the two supporting members are connected to each other in staggered arrangement of the first side arms and the second side arms.

10. The keyswitch of claim 7, wherein shaft is located at the middle point or the terminal far away the connecting portion of the first side arm.

11. The keyswitch of claim 7, wherein the hole is located at the middle point or the terminal away from the connecting portion of the second arm.

12. The keyswitch of claim 7, wherein the two supporting member have the same shapes and the shaft protrudes toward or away from the second side arm.

13. A keyboard, comprising:
a base;
a plurality of keycaps, configured on the base; and
a plurality of supporting structures, correspondingly configured between and connected to the keycaps and the base to enable the corresponding keycaps to be movable relatively to the base, each of the keycaps comprising:
two supporting members, each of the two supporting members having a connecting portion, a first side arm, and a second side arm, the first side arm and the second side arm being connected opposite to the connecting portion respectively, the first side arm protruding to form an shaft, the second side arm forming a hole corresponding to the shaft, wherein the shaft of each of the two supporting member is capable of being rotatable contained in the hole of another supporting member respectively.

14. The keyboard of claim 13, wherein the shape of the supporting member is approximately a U shape.

15. The keyboard of claim 13, wherein the two supporting members are connected to each other in staggered arrangement of the first side arms and the second side arms.

16. The keyboard of claim 13, wherein shaft is located at the middle point or the terminal far away the connecting portion of the first side arm.

17. The keyboard of claim 13, wherein the hole is located at the middle point or the terminal away from the connecting portion of the second arm.

18. The keyboard of claim 13, wherein the two supporting member have the same shapes and the shaft protrudes toward or away from the second side arm.
